(19) United States
(12) Patent Application Publication
(10) Pub. No.: US 2023/0265331 A1
(43) Pub. Date: Aug. 24, 2023

(54) LATENT HEAT STORAGE MATERIAL FOR ULTRA-COLD APPLICATIONS AND CONTAINER FOR TEMPERATURE-CONTROLLED TRANSPORT AT ULTRA-COLD TEMPERATURES

(71) Applicant: va-Q-tec AG, Würzburg (DE)

(72) Inventors: Thomas Wollheim, Erfurt (DE); Peter Hoock, Augsburg (DE); Stefan Hiebler, Garmisch-Partenkirchen (DE); Christoph Rathgeber, München (DE); Henri Schmit, München (DE); Simon Pöllinger, München (DE); Stefanie Tafelmeier, Landshut (DE)

(21) Appl. No.: 18/174,219

(22) Filed: Feb. 24, 2023

(30) Foreign Application Priority Data
Feb. 24, 2022 (DE) 102022104371.1

(51) Int. Cl. C09K 5/06; B65D 81/38

(52) U.S. Cl. CPC C09K 5/06; B65D 81/3818; B65D 81/382

(57) ABSTRACT

A latent heat storage material for ultra-cold applications, comprising at least one lithium salt, at least one solvent, and at least one nucleating agent, wherein the at least one nucleating agent is selected from one or a combination of sodium carbonate, lithium carbonate, potassium carbonate, barium fluoride, sodium nitrate, and/or lithium hydroxide.

### CROSS-REFERENCE TO RELATED APPLICATIONS

This patent application claims priority to German utility patent application number 10 2022 104 371.1 filed Feb. 24, 2022 and titled “latent heat storage material for ultra-cold applications and container for temperature-controlled transport at ultra-cold temperatures”. The subject matter of patent application number 10 2022 104 371.1 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The present invention relates to a latent heat storage material for ultra-cold applications and a container for temperature-controlled transport at ultra-cold temperatures according to the respective independent claim.

### BACKGROUND

Ultra-cold applications may particularly include ultra-low temperature applications in a temperature range between -50° C. and -85° C., and more particularly in a temperature range between -60° C. and -85° C.

Latent heat storage materials are also known as phase change materials (PCMs). They refer to a material that uses a change of aggregate state, usually between solid and liquid, in a defined temperature range for a heating/refrigeration application. The material composition of the latent heat storage material is designed for a desired temperature range.

The phase change can be utilized reversibly, i.e. the melting and crystallization transition (change between the liquid and solid aggregate state) can be undergone repeatedly, and enthalpy absorbed or released by the latent heat storage material can be used for heating/refrigeration applications. When undergoing a phase change, latent heat storage materials provide a high thermal energy storage capability in a narrow temperature range around their phase change temperature.

Latent heat storage materials are frequently used to store and/or transport materials at a constant temperature. Examples include the transport of pharmaceuticals, such as vaccines, or foods, which are temperature sensitive. In particular, many pharmaceutical and medical products require storage at particularly low temperatures. One example is mRNA vaccines against COVID-19, which must be stored in a temperature range of approx. -80° C. to -60° C., corresponding to an ultra-low temperature range, to prevent degradation until the time when they are used. Another example is the transport of tissue and blood samples, or blood plasma and blood plasma derivatives. Reliable storage at such low temperatures for global transport of such transport goods represents one of the greatest obstacles for corresponding logistics processes.

Here, latent heat storage materials for latent heat storage elements, for example embedded in packaging systems to keep the temperature-sensitive materials in a desired temperature range during transport, represent a technically, economically and ecologically advantageous solution compared to other coolants, such as dry ice (phase change at -78.5° C.).

Latent heat storage materials comprising polymers, such as various n-alkanes, are known from the prior art, for example. For example, US 9 556 373 B2 discloses a gel comprising a PCM comprising, for example, n-tetradecane, n-hexadecane or n-octadecane. It is also disclosed that the relative proportions of various n-alkanes in a mixture can be used to adjust the phase change temperature. However, such a latent heat storage material is not suitable for use at ultra-low temperatures, especially for ultra-low temperature applications in a temperature range between -50° C. and -85° C.

In general, latent heat storage materials for ultra-cold applications (but also for applications in other temperature ranges) often exhibit severe overcooling. In this case, the use of a nucleating agent can prevent or at least reduce overcooling. However, it can be difficult to find a suitable nucleating agent. Overcooling means that the latent heat storage material in the liquid aggregate state can be cooled far below its melting temperature without the material changing to a solid aggregate state by crystallization. Thus, the enthalpy associated with a phase transition is not released either and the cold storage density is significantly reduced. Frequently it is not possible, or only with difficulty, to achieve the necessary low nucleation temperatures for such materials with the aid of common refrigeration machines. Even if they could be achieved, the necessary additional energy expenditure for undershooting these nucleation temperatures would be disadvantageous from a technical, economic and ecological point of view.

### SUMMARY

It is the object of the present invention to provide a latent heat storage material for ultra-cold applications which overcomes the disadvantages of the prior art and, in particular, has melting and crystallization temperatures particularly close to each other due to the presence of an advantageous nucleating agent, and further to provide a container for temperature-controlled transport at ultra-cold temperatures.

The invention encompasses a latent heat storage material for ultra-cold applications, comprising at least one lithium salt, at least one solvent, and at least one nucleating agent, wherein the at least one nucleating agent is selected from one or a combination of sodium carbonate, lithium carbonate, potassium carbonate, barium fluoride, sodium nitrate, and/or lithium hydroxide.

The use of these nucleating agents allows the latent heat storage material to have a crystallization temperature that is close to the melting temperature. In this context, the at least one nucleating agent can comprise one or more of the above-mentioned substances individually or in a mixture. In this regard, the compound having lithium bromide as the lithium salt and water as the solvent, in particular sodium carbonate and lithium carbonate, has proven to be particularly advantageous for crystallization and ultra-low temperature applications in a temperature range between -50° C. ≥ T ≥ -85° C. Further, the latent heat storage material comprises the nucleating agent selected from the above substances either by direct addition in the form of the salt of the substance, or by reaction (for example, from precipitation) from the corresponding ions present in the latent heat storage material dissolved in a liquid phase (by addition of other salts).

### BRIEF DESCRIPTION OF THE DRAWINGS

In the following, the invention is explained in greater detail by means of exemplary embodiments:

FIG. 1 shows the temporal progression of cooling and heating of an exemplary embodiment of a latent heat storage material not according to the invention;

FIG. 2 shows the temporal progression of cooling and heating of a first exemplary embodiment of a latent heat storage material according to the invention;

FIG. 3 shows the temporal progression of cooling and heating of a second exemplary embodiment of a latent heat storage material according to the invention; and

FIG. 4 shows a cross-section through a container for temperature-controlled transport at ultra-cold temperatures.

### DETAILED DESCRIPTION

According to a preferred aspect, the at least one lithium salt comprises lithium bromide and/or lithium chloride.

According to a preferred aspect, the at least one solvent comprises water.

The use of lithium bromide and water enables to provide a latent heat storage material having a melting temperature Tₛ in a range between -75° C. and -60° C.

According to an advantageous aspect, the latent heat storage material comprises the at least one lithium salt in a range between 20 wt.-% to 45 wt.-%.

These compositions have proven to be particularly advantageous for ultra-low temperature applications in a temperature range between -50° C. ≥ T ≥ -85° C.

According to a particularly advantageous aspect, the proportion and/or composition of the at least one lithium salt and the proportion and/or composition of the at least one solvent are selected such that the melting temperature Tₛ of the latent heat storage material is in a range between -60° C. ≥ Ts ≥ -85° C., in particular in a range between -60° C. ≥ Ts ≥ -75° C.

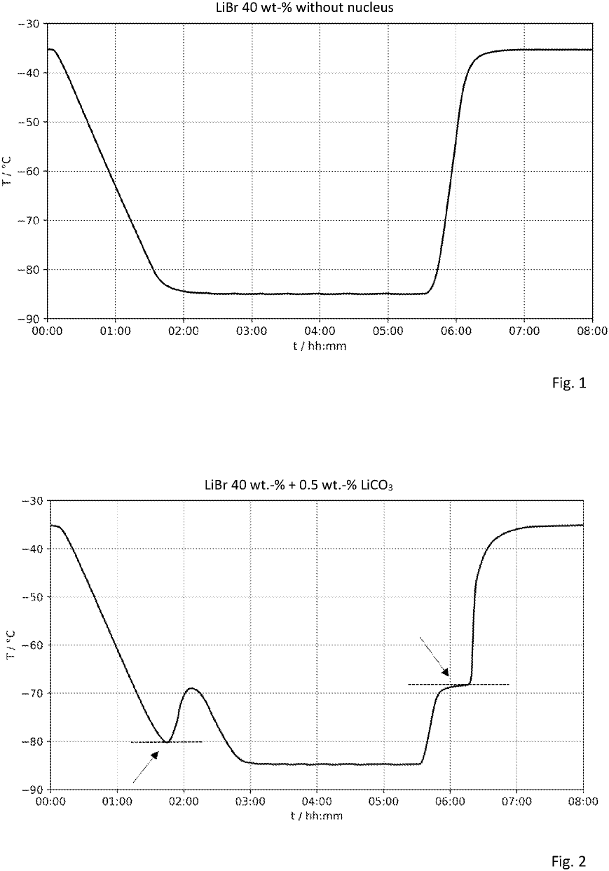

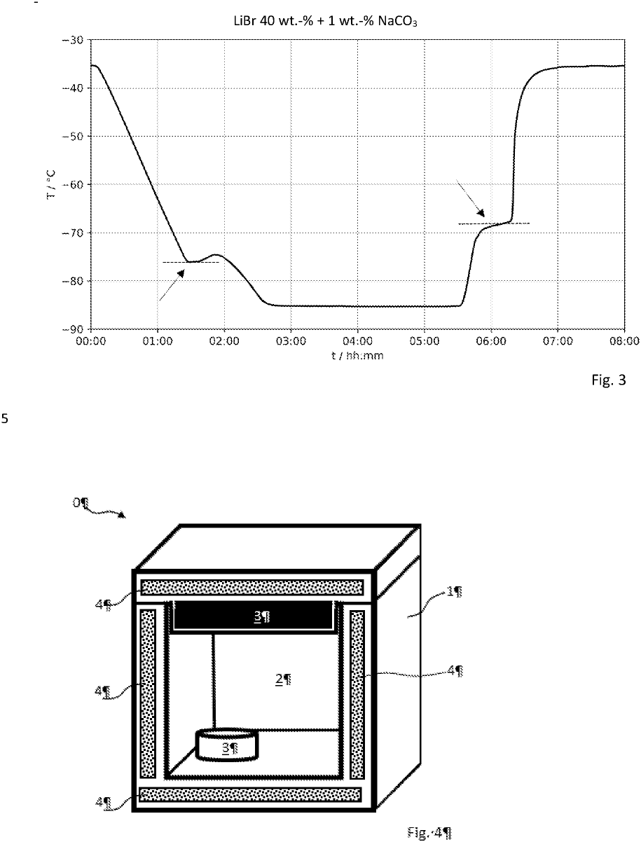

Exemplary embodiments are described in connection with FIG. 2 and FIG. 3.

According to a preferred aspect, the proportion and/or composition of the nucleating agent is selected such that the following applies for the crystallization temperature T_{K} of the latent heat storage material and the melting temperature Tₛ of the latent heat storage material: 0 K ≥ T_{K} - T_{S} ≥ -15 K, in particular 0 K ≥ T_{K} - T_{S} ≥ -10 K.

Thus, no severe overcooling of the latent heat storage material occurs, so that the latent heat storage material can be used in an economically and ecologically advantageous manner.

According to a further advantageous aspect, the latent heat storage material comprises the at least one nucleating agent in a range between 0.01 wt.-% to 30 wt.-% and in particular in a range between 0.5 wt.-% to 5 wt.-%.

This concentration of nucleating agent ensures that when the latent heat storage material is cooled down, it does not overcool too much without a crystallization process starting. In this regard, sodium carbonate and/or lithium carbonate with a proportion in a range between 0.5 wt.-% and 1.0 wt.-% has proven to be particularly advantageous.

The invention further encompasses a container for temperature-controlled transport at ultra-cold temperatures, comprising a container wall completely enclosing an interior space, and at least one latent heat storage element, comprising a latent heat storage material as described above, wherein the at least one latent heat storage element is disposed within the interior space and/or in the container wall.

By the container comprising at least one latent heat storage element, comprising a latent heat storage material as described above, the container is suitable for ultra-low temperature applications, for example temperature controlled transport, in a temperature range between -50° C. ≥ T ≥ -85° C., in particular in a temperature range between -60° C. ≥ T ≥ -85° C. In particular, this allows the air in the interior space to be maintained in a temperature range between -50° C. ≥ T ≥ -85° C., especially in a temperature range between -60° C. ≥ T ≥ -85° C., throughout the period of transport.

Such a container is technically, economically and environmentally advantageous, especially compared to other containers using dry ice for ultra-low temperature applications.

According to an advantageous aspect, the container comprises at least one vacuum insulation element arranged in the container wall.

By arranging at least one vacuum insulation element in the container wall, the insulation capability of the container is greatly enhanced and the time period for transport at ultra-low temperatures can be extended.

First, the process of cooling and heating of an exemplary embodiment of a latent heat storage material not according to the invention is explained in more detail with reference to FIG. 1. Here, the exemplary embodiment of the latent heat storage material not according to the invention comprises lithium bromide at 45 wt.-% and water at 60 wt.-%. In addition, the latent heat storage material does not comprise a nucleating agent.

The temporal progression demonstrates that no crystallization plateau and no melting plateau are formed during the cooling and heating of this latent heat storage material. No crystallization is observed in this latent heat storage material until it cools down to a temperature of -85° C. for several hours. This is an indication of overcooling of the latent heat storage material to below -85° C. This demonstrates the unsuitability of this latent heat storage material not according to the invention, especially for latent heat storage application in an ultra-low temperature range between -50° C. ≥ T ≥ -85° C.

The same applies to a latent heat storage material, comprising an unsuitable nucleating agent and/or a nucleating agent in an unsuitable concentration.

FIG. 2 shows a temporal progression of cooling and heating of a first exemplary embodiment of a latent heat storage material according to the invention.

Here, the latent heat storage material comprises lithium bromide at 45 wt.-% and water at 60 wt.-%. In addition, the latent heat storage material comprises lithium carbonate as a nucleating agent at 0.5 wt.-%.

The temporal progression reveals that crystallization is formed at approx. -80° C. during cooling, and that a melting plateau is created at approx. -68° C. during heating. This latent heat storage material thus has crystallization (Tc) and melting (Ts) temperatures that are close to each other.

Accordingly, the specified latent heat storage material is suitable for latent storage of refrigeration/heat energy for applications in an ultra-low temperature range between -50° C. ≥ T ≥ -85° C., in particular between -60° C. ≥ T ≥ -85° C.

FIG. 3 shows a temporal progression of cooling and heating of a second exemplary embodiment of a latent heat storage material according to the invention.

Here, the latent heat storage material comprises lithium bromide at 40 wt.-% and water at 60 wt.-%. In addition, the latent heat storage material comprises sodium carbonate as a nucleating agent at 1.0 wt.-%.

The temporal progression shows that crystallization forms at approx. -76° C. during cooling, and that a melting plateau forms at approx. -68° C. during heating. This latent heat storage material thus has crystallization and melting temperatures that are close to each other.

Accordingly, the specified latent heat storage material is suitable for latent storage of refrigeration/heat energy in an ultra-low temperature range between -50° C. ≥ T ≥ -85° C., in particular between -60° C. ≥ T ≥ -85° C.

FIG. 4 shows a cross-section through a container 0 for temperature-controlled transport at ultra-low temperatures.

This container comprises a container wall 1 with side walls and a lid. The container wall 1 completely encloses the interior space 2. A vacuum insulation element 4 is arranged inside each of the container walls 1 (side walls and lid). This provides optimum insulation of the container, extending the time period for transport at ultra-low temperatures compared to containers without vacuum insulation elements 4.

A latent heat storage element 3 is each arranged inside the interior space 2 and in the lid part of the container wall 1. The latent heat storage elements 3 thereby comprise a latent heat storage material as described above, being suitable for latent storage of refrigeration/heat energy in an ultra-low temperature range between -50° C. ≥ T ≥ -85° C.

Thus, the container 0 is also suitable for ultra-low temperature applications, for example temperature-controlled transport, in a temperature range between -50° C. ≥ T ≥ -85° C., since the air in the interior space 2 is maintained in a temperature range between -50° C. ≥ T ≥ -85° C. throughout the period of transport.

Such a container 0 is technically, economically and ecologically advantageous, especially compared to other containers using dry ice for ultra-low temperature applications, since the latent heat storage materials in the form of latent heat storage elements 3 are easily transportable and reusable.

What is claimed is:

1. Latent heat storage material for ultra-cold applications, comprising at least one lithium salt, at least one solvent, and at least one nucleating agent, wherein the at least one nucleating agent is selected from one or a combination of sodium carbonate, lithium carbonate, potassium carbonate, barium fluoride, sodium nitrate, and/or lithium hydroxide.

2. Latent heat storage material according to claim 1, wherein said at least one lithium salt comprises lithium bromide and/or lithium chloride.

3. Latent heat storage material according to claim 1, wherein the at least one solvent comprises water.

4. Latent heat storage material according to claim 1, comprising the at least one lithium salt in a range between 20 wt.-% to 45 wt.-%.

5. Latent heat storage material according to claim 1, wherein the proportion and/or composition of the at least one lithium salt and the proportion and/or composition of the at least one solvent is selected such that the melting temperature Ts of the latent heat storage material is in a range between -60° C. ≥ Ts ≥ -85° C., in particular in a range between -60° C. ≥ Ts ≥ -75°.

6. Latent heat storage material according to claim 5, wherein the proportion and/or the composition of the at least one nucleating agent is selected such that the following applies to the crystallization temperature T_{K} of the latent heat storage material and the melting temperature Ts of the latent heat storage material: 0 K ≥ T_{K} - Ts ≥ -15 K, in particular 0 K ≥ T_{K} - Tₛ ≥ -10 K.

7. Latent heat storage material according to claim 6, comprising the at least one nucleating agent in a range between 0.01 wt.-% to 30 wt.-%, in particular in a range between 0.5 wt.-% to 5 wt.-%.

8. Container for temperature-controlled transport at ultra-cold temperatures, comprising a container wall which completely encloses an interior space, and at least one latent heat storage element comprising a latent heat storage material according to claim 1, wherein the at least one latent heat storage element is disposed within the interior space and/or in the container wall.

9. Container according to claim 8, comprising at least one vacuum insulation element disposed in the container wall.
